(19) United States
(12) Patent Application Publication
(10) Pub. No.: US 2017/0046431 A1
(43) Pub. Date: Feb. 16, 2017

(54) TASK-LEVEL SEARCH ENGINE EVALUATION

(71) Applicant: Microsoft Technology Licensing, LLC, Redmond, WA (US)

(72) Inventors: Imed Zitouni, Bellevue, WA (US); Jinyoung Kim, Bellevue, WA (US); Hyun Joon Jung, Cupertino, CA (US); Ahmed Awadallah, Redmond, WA (US)

(21) Appl. No.: 14/822,905

(22) Filed: Aug. 11, 2015

(51) Int. Cl. G06F 17/30; G06N 99/00

(52) U.S. Cl. CPC G06F 17/30864; G06F 17/30389; G06F 17/30598; G06F 17/3053; G06N 99/005

(57) ABSTRACT

Techniques for evaluating the quality of results obtained by a search engine. In an aspect, an evaluation platform utilizes task-level formulation to increase the accuracy of search result quality evaluation. Furthermore, initial queries may be reformulated until search results are deemed to satisfy the task description. Side-by-side comparison of results from multiple search engines is further provided to enhance the sensitivity of evaluation. Alternative aspects provide for collection of behavioral signals for training a classifier to classify the quality of an evaluator's feedback, as may be applied in, e.g., a crowd-sourcing context.

### BACKGROUND

In recent years, widespread use of the Internet has led to proliferation of a vast amount of information. Typically, users rely heavily on Internet search engines to quickly sift through and locate the information relevant to their needs. As the Internet continues to expand, search engine developers must devote a considerable amount of resources to research, develop, and implement faster and more powerful search engines to return the most relevant results.

To evaluate and assess search engine performance, developers may conduct trials employing human evaluators to rate search engine performance. For example, a group of human evaluators may be provided with a reference (or “pre-configured”) search query, along with corresponding results returned by a search engine, and may be asked to rate the relevance of the results to the query, e.g., on a scale of 0-10. It will be appreciated that running such trials comprehensively over all different types of information queries may be extremely costly. Furthermore, to obtain reliable ratings, a large number of human evaluators may need to be employed, further increasing cost.

Accordingly, to aid in the design of better search engines, it is critical to provide techniques for designing an automated platform for accurately evaluating search engine performance across a wide range of scenarios.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly, various aspects of the subject matter described herein are directed towards techniques for designing a search engine evaluation platform that obtains accurate feedback from evaluators when evaluating search engine performance. In an aspect, a search engine evaluator is provided with a task description and initial query through a user interface. Search results corresponding to the initial query are retrieved and displayed. Explicit evaluator input may be received indicating whether the search results adequately satisfy the task description. The evaluator is presented with options to reformulate the query if the search results are unsatisfactory.

Further aspects provide for side-by-side comparison of results from different search engines to increase sensitivity, and collection of evaluators' behavioral signals. The collected signals may be used to train a classifier to determine evaluator quality and identify ratings associated with reliable evaluators. The classifier may be used to classify the quality of evaluators' feedback based on their behavioral signals, thus reducing the costs of evaluating and optimizing search engines.

Other advantages may become apparent from the following detailed description and drawings.

### BRIEF DESCRIPTION OF THE DRAWINGS

FIG. 1 shows an illustrative Search Engine Results Page (SERP) for a single-page query-level search engine evaluation scheme.

FIG. 2 illustrates an exemplary embodiment of a search engine evaluation method according to the present disclosure.

FIG. 3 illustrates an exemplary user interface (UI) for executing a method using an illustrative task description and query string.

FIG. 4 shows illustrative results for a query reformulation.

FIGS. 5A and 5B show an exemplary embodiment of a UI wherein a side-by-side (SBS) comparison of search results from different search engines is further displayed.

FIG. 6 illustrates an exemplary embodiment of a search engine evaluation method according to the present disclosure.

FIG. 7 illustrates an exemplary embodiment of an evaluator quality classifier trainer using techniques of the present disclosure.

FIG. 8 illustrates an exemplary embodiment of an evaluator quality classifier according to techniques of the present disclosure.

FIG. 9 illustrates an exemplary embodiment of a method for training and classifying evaluators according to the present disclosure.

FIG. 10 illustrates an exemplary embodiment of a method according to the present disclosure.

FIG. 11 illustrates an exemplary embodiment of an apparatus according to the present disclosure.

FIG. 12 illustrates an alternative exemplary embodiment of an apparatus according to the present disclosure.

FIG. 13 illustrates an exemplary embodiment of an evaluator quality classifier according to the present disclosure.

FIG. 14 illustrates an alternative exemplary embodiment of a method according to the present disclosure.

FIG. 15 illustrates a further alternative exemplary embodiment of a method according to the present disclosure.

### DETAILED DESCRIPTION

Various aspects of the technology described herein are generally directed towards techniques for designing an automated platform for search engine evaluation allowing task-level query reformulation to maximize evaluator reliability.

The detailed description set forth below in connection with the appended drawings is intended as a description of exemplary means “serving as an example, instance, or illustration,” and should not necessarily be construed as preferred or advantageous over other exemplary aspects. The detailed description includes specific details for the purpose of providing a thorough understanding of the exemplary aspects of the invention. It will be apparent to those skilled in the art that the exemplary aspects of the invention may be practiced without these specific details. In some instances, well-known structures and devices are shown in block diagram form in order to avoid obscuring the novelty of the exemplary aspects presented herein.

Search engine designers are working continuously to improve the performance of Internet search engines, e.g., in terms of comprehensiveness of information searched, relevancy of search results returned, and speed of search execution. To assess how well search engines perform across a wide variety of contexts, a search engine evaluation entity (hereinafter “evaluation entity”) may obtain and/or solicit input on search engine performance from various sources. For example, data logs of actual search queries performed by Internet users using the search engine may be stored and analyzed. Furthermore, specific evaluation schemes may be designed to target certain types of information queries in detail. Such evaluation schemes may employ human evaluators to rate search engine quality for a specific set of pre-formulated search queries. Human evaluators may include, e.g., general Internet users enlisted specifically for this purpose (e.g., “crowd” users), and/or judges possessing specific training in the techniques of search results relevancy determination (e.g., reference evaluators or “gold” users).

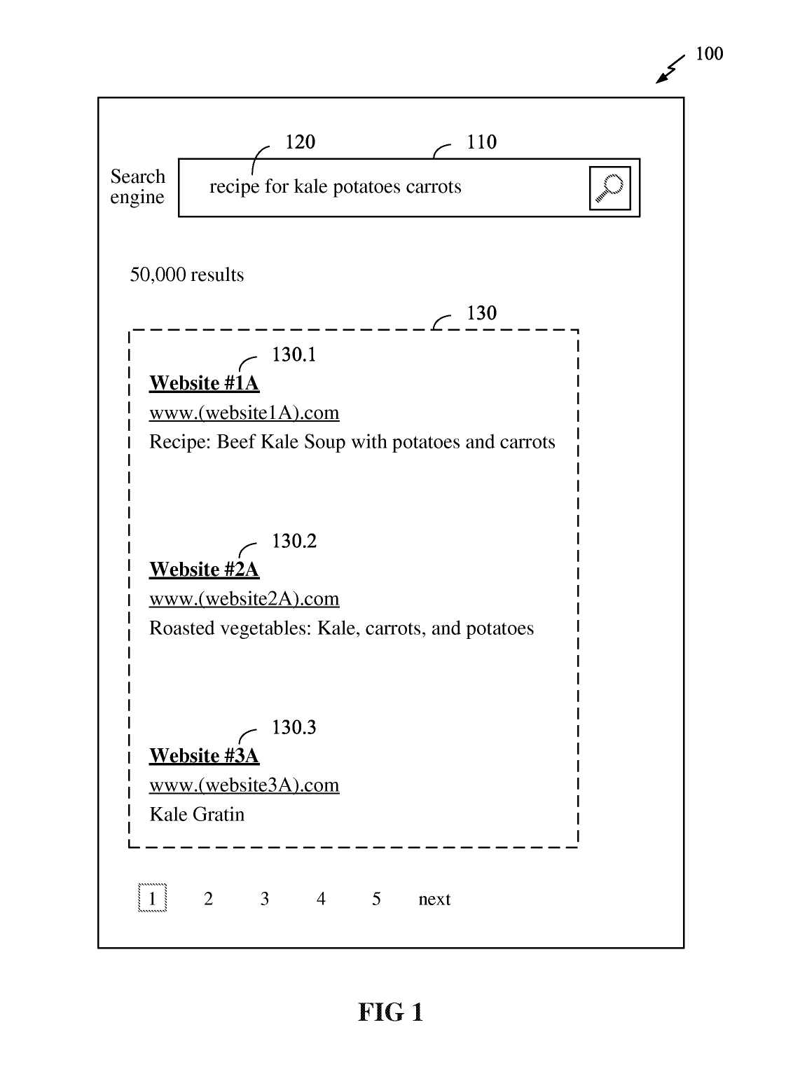

FIG. 1 shows an illustrative Search Engine Results Page (SERP) 100 for a single-page query-level search engine evaluation scheme. Note FIG. 1 is shown for illustrative purposes only, and is not meant to limit the scope of the present disclosure to any particular types of search queries, results display formats, etc.

In FIG. 1, SERP 100 includes search engine query field 110, example query 120, and a plurality 130 of corresponding search results 130.1, 130.2, 130.3 returned by a search engine under evaluation. Each of results 130.1, 130.2, 130.3 generally has an associated Universal Resource Locator (URL) linked to the webpage associated with the corresponding search result.

Known techniques for evaluating search engine effectiveness include, e.g., submitting a single pre-configured fixed query (such as query 120) to a search engine under evaluation, and displaying a single page of the top results along with the original query to a human evaluator (hereinafter “evaluator”) for evaluation. This evaluation scheme is known as “single-page query-level evaluation.” In typical scenarios, the evaluator is asked to judge how relevant the returned search results are in satisfying the given query. For example, the evaluator may be asked to provide a “relevance score,” e.g., on a scale from 0 to 10, indicating how well the returned search results satisfy the given query. This procedure may be repeated using multiple evaluators, and a composite relevance score for the search engine may then be estimated by, e.g., averaging or otherwise combining the relevance scores submitted by the multiple evaluators.

For example, in an illustrative test scenario, 10,000 evaluators may be asked to evaluate the relevance of results for a query such as query 120 of FIG. 1. A first evaluator may assign a score of 7 (on a scale of 0 to 10, with 10 indicating maximal relevance) to results 130, a second evaluator may assign a score of 6, etc., and the average of the 10,000 relevance scores may correspond to a score of, e.g., 7.7, for SERP 100. It will be appreciated that employing a greater number of evaluators may lead to a more statistically meaningful score for a given query-results pair. However, more evaluators may lead to greater cost and greater variance in evaluator quality. In view of these constraints, it would be desirable to design an evaluation scheme that best affords each evaluator the opportunity to accurately judge the relevance of search engine results, while minimizing time and resources.

It will be appreciated that the single-page query-level evaluation scheme described hereinabove suffers from several disadvantages in attaining the aforementioned objectives. First, different evaluators may have different criteria for evaluating the relevance of search results. For example, for the illustrative query string 120 (“recipe for kale potatoes carrots”), an evaluator Bob may judge the results favorably if they provide a diverse sample of recipes for different dishes, e.g., “soup” 130.1, “roasted” 130.2, and “gratin” 130.3. Based on this diversity of results, Bob may give the search results a high score, e.g., 10 out of 10. In contrast, another evaluator Jane may notice that result 130.3 leaves out the terms “potatoes” and “carrots” from the original query string 120, i.e., result 130.3 is under-inclusive. Accordingly, Jane may give the search results a lower score, e.g., 6 out of 10. In view of these different criteria, it will be appreciated that a large variance may be present in the numerical evaluation scores across different evaluators. This undesirably impacts the accuracy and cost of the evaluation.

Second, in some instances, it may be difficult for an evaluator to infer the true intent behind a pre-configured query string, which is often formulated using “machine language.” For example, a sample query string such as “Idaho state song” may be ambiguous. Does the query pertain to a song about the state of Idaho? Or the official song for Idaho State University? It would also be desirable to address the inaccuracies in search engine evaluation arising from imperfect query formulation.

Accordingly, techniques are disclosed herein to address the aforementioned problems, to provide a more efficient and accurate evaluation platform for judging the quality of search engine results.

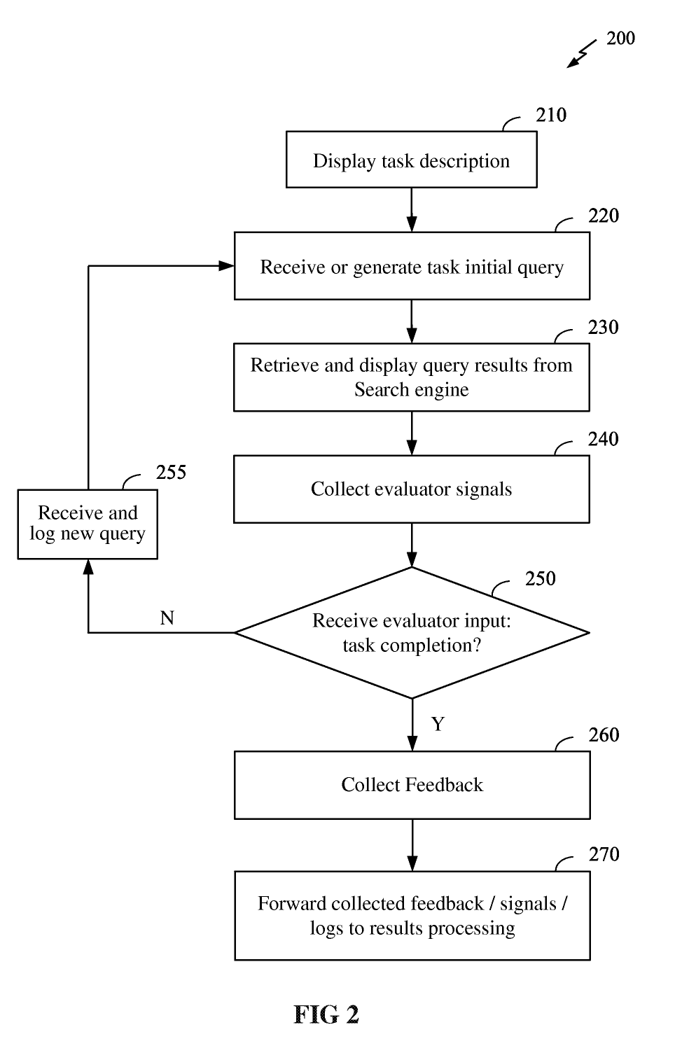

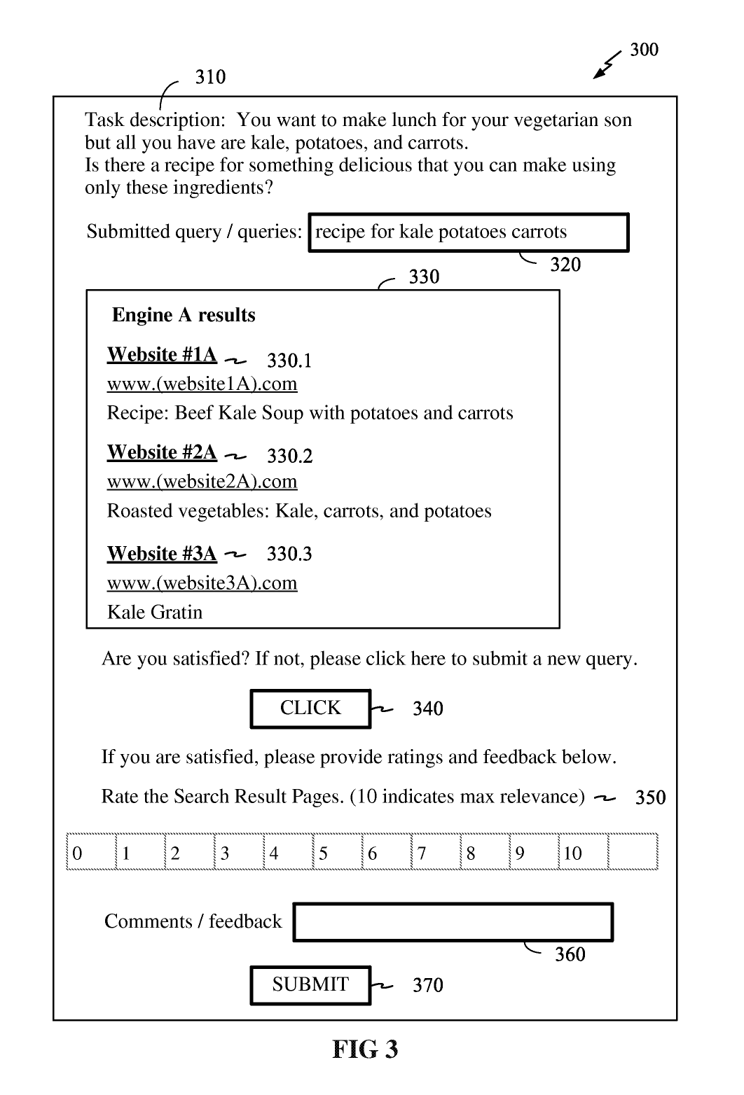

FIG. 2 illustrates an exemplary embodiment 200 of a search engine evaluation method according to the present disclosure. Note the discussion of FIG. 2 will proceed also with reference to FIG. 3, which illustrates an exemplary user interface (UI) 300 for executing method 200 using an illustrative task description and query string. Note both method 200 and UI 300 are shown for illustrative purposes only, and are not meant to limit the scope of the present disclosure to any particular task descriptions, query strings, search results, or user interface formats shown.

In FIG. 2, at block 210, a task description is displayed through a user interface. The task description may correspond to a detailed formulation of the search task, and is generally formulated using “human language,” as opposed to machine language, for ready comprehension by the human evaluator. In an exemplary embodiment, the task definition may be defined and formulated by an evaluation entity, or any other entity.

An illustrative task description 310 is shown at field 310 in FIG. 3: “You want to make lunch for your vegetarian son, but all you have are kale, potatoes, and carrots. Is there a recipe for something delicious that you can make using only these ingredients?” It will be appreciated that task description 310 more clearly specifies to the evaluator the true intent behind query string 320. Accordingly, the evaluator is afforded a better opportunity to assign a precise, reproducible score to search results returned by a search engine.

Note task description 310 is shown for illustrative purposes only, and is not meant to limit the scope of the present disclosure to any particular types of task descriptions that may be accommodated. Other examples of task descriptions may be readily formulated by one of ordinary skill in the art. Some further illustrative examples are provided hereinbelow for reference:

Task description 2: “Next week you will start as a teaching aide for years one and two. You were told that the kids will be learning about digraphs—what are good ways to teach these phonics?”

Task description 3: “You are about to take a trip to Key West for your honeymoon. To celebrate your marriage, you have planned a dinner at a nice restaurant, but the reservation is not until 8 pm. You would like to know places nearby that have a happy hour to go to before dinner.”

It will be appreciated that a large variety of task descriptions may effectively allow sampling across diverse facets of the search space, to afford greater visibility into the actual performance of the search engine. In certain cases, for the purposes of “calibrating” human evaluators' evaluation and judgment abilities, certain task descriptions may be formulated that have a specific, precise answer, such as Task Descriptions 4 and 5 below.

Task Description 4: “What is the state flower of Idaho?”

Task Description 5: “What is the distance from San Francisco to New York?”

In these cases, an evaluator may be asked to provide answers to the task descriptions, which answers are then compared with the precise answers to determine the quality of that evaluator's feedback and responses.

Returning to FIG. 2, at block 220, an initial query string corresponding to the defined task description is received or generated. For example, field 320 of UI 300 shows the initial query string to be “recipe for kale potatoes carrots.” In an exemplary embodiment wherein the initial query is “pre-configured,” the initial query string 320 may be automatically generated from task description 310, e.g., using automated keyword extraction techniques. In an alternative exemplary embodiment utilizing a “pre-configured” initial query, the evaluation entity can provide the initial query string along with the task description to the evaluator. In an exemplary embodiment wherein an initial query is not pre-configured, the evaluator may supply the initial query string based on the displayed task description. Such alternative exemplary embodiments are contemplated to be within the scope of the present disclosure.

At block 230, search results corresponding to the query string are received from the search engine and displayed for evaluation. In particular, the initial (or subsequently generated) query string from block 220 may be submitted to the search engine to be evaluated, search results (e.g., the first page or first SERP) may be retrieved from the search engine corresponding to the initial query, and the retrieved search results may be received by a module implementing the user interface. The results may then be displayed through the UI 300. For example, illustrative results 330 returned by a search engine responsive to initial query 320 are shown in FIG. 3.

At block 240, behavioral signals may be collected from the evaluator. In particular, a software application generating UI 300 may also collect a variety of behavioral signals while the evaluator is working on the task, without specifically prompting the evaluator for input. Signals may include, e.g., time spent on a task by an evaluator, frequency and location of mouse clicks, idle time, eye tracking measurements, etc. Signals may further include number of seconds spent per task, time spent outside the task (excludes time spent on viewing clicked URL's) per task, number of logged mouse move events per task, number of logged mouse move events per second and per task, dwell times between mouse move events per task, dwell times between clicks per second and per task, mouse move dwell times over all mouse move events in an evaluator's tasks, number of logged mouse clicks per task, number of logged mouse clicks per second and per task, dwell times between clicks per task, dwell times between clicks per second and per task, click dwell times over full set of clicks in evaluator's tasks, time elapsed before first click per task, number of URL's clicked per task, time spent on viewing a web page after clicking on its URL per task, number of copy-paste events per task (e.g., into comment field), number of scrolling events per task, number of window resize events per task, etc.

In an exemplary embodiment, at block 240, method 200 may also continuously create an activity log detailing evaluator activities, logged over multiple task descriptions. Such an activity log may include signals such as total number of tasks completed by an evaluator, total number of days when evaluator worked, average rate of evaluations per hour, number of relevance or preference evaluations per task (e.g., number of times an evaluator changed his or her mind), ratio of optional evaluations completed per task, number of characters in comment field per task, proportion of tasks with no comment, proportion of tasks when no URL's (e.g., URL's listed in search results) were clicked, proportion of tasks where the evaluator provided additional optional judgments, etc.

At block 250, input is received regarding whether the evaluator believes the defined task has been satisfactorily addressed by the search results returned. If the evaluator indicates yes, method 200 continues to block 260. If the evaluator indicates no, method 200 continues to block 255. In an exemplary embodiment, such evaluator input may be received using buttons, menu items, etc., such as buttons 340, 370 in UI 300.

At block 255, in response to the evaluator indicating unsatisfactory results, a new query string may be received from the evaluator and logged. In an exemplary embodiment, the new query string may correspond to a reformulation of the initial (or any previously submitted) query string based on the previous results returned. The evaluator may formulate the new query string to generate more relevant search results for the task. Accordingly, clicking on button 340 may allow the evaluator to modify the initial (or other prior) query string, and resubmit the reformulated query string to retrieve a new set of results from the search engine.

Note in an exemplary embodiment, the functionality of blocks 250 and 255 may be combined. For example, entry of a new or reformulated query string may automatically indicate user dissatisfaction with initial search results. Such alternative exemplary embodiments are contemplated to be within the scope of the present disclosure.

In an exemplary embodiment, feedback may be collected from the evaluator prior to resubmitting a new query string.

Following block 255, method 200 returns to block 230, wherein the new query string is resubmitted to the search engine, and search results (e.g., the first page or first SERP) are retrieved corresponding to the resubmitted query.

At block 260, upon receiving evaluator input that the defined task has been satisfactorily addressed (e.g., after multiple iterations of blocks 230-255 if necessary), the evaluator's feedback is collected. In an exemplary embodiment, an evaluation score may be received from the evaluator indicating the relevance of search results 330. In the exemplary embodiment shown, the evaluation score may be received from the evaluator clicking one of a plurality of buttons 350 indicating a numerical score from 0 to 10. Note in alternative exemplary embodiments, the evaluator input may be received using any alternative formats, e.g., using a graphical designation, direct entry of a number, numerical scores over any numerical ranges, etc. Such alternative exemplary embodiments are contemplated to be within the scope of the present disclosure.

In addition to field 350, Comments/Feedback field 360 solicits evaluator input in the form of textual feedback. Such feedback may include a written answer to the task 310, and/or a link to the website supplying the answer. For example, the evaluator can type in field 360 a specific website that satisfied task 310. Further comments in field 360 may include feedback regarding technical issues, if something is not clear, if only certain sites are satisfactory or unsatisfactory, questions that the evaluator may have, positive experiences, etc.

At block 270, the evaluator's collected feedback, signals, and activity logs are forwarded to an analysis module (not shown in FIG. 2) for further results processing.

In view of the description hereinabove, it will be appreciated that method 200 and UI 300 afford certain advantages over the single-page query-level evaluation platform described with reference to FIG. 1. As earlier mentioned hereinabove, different evaluators may have different criteria for evaluating the relevance of search results, potentially causing different evaluators to evaluate the same SERP using different criteria, e.g., Bob using diversity of results, and Jane using inclusiveness of each result. As mentioned hereinabove, using different criteria for scoring may result in a large variance in the numerical scores.

Method 200 and UI 300 advantageously reduce such differences in judging criteria. In particular, evaluators are more likely to use the same criteria for evaluation, in view of the clearly defined task description displayed at block 210. For example, based on task description 310 as earlier stated hereinabove, it will be clear to evaluators that search results (and corresponding query strings) should be judged more relevant if they suggest vegetarian dishes for children. Since none of the results 330 specifically mentions vegetarian recipes for children, evaluators such as Bob and Jane might agree that the topic is not well-addressed by the search results. Accordingly, the evaluators would likely choose to reformulate and submit a new query.

For example, Bob may re-formulate his query as “vegetarian recipe kale potatoes carrots for kids.” The re-formulated query string may be, e.g., a modification of the initial query string to return search results more likely to address the task description 310. In an exemplary embodiment, method 200 processes the query reformulation, e.g., at block 255, and retrieves the corresponding new results, e.g., at block 230.

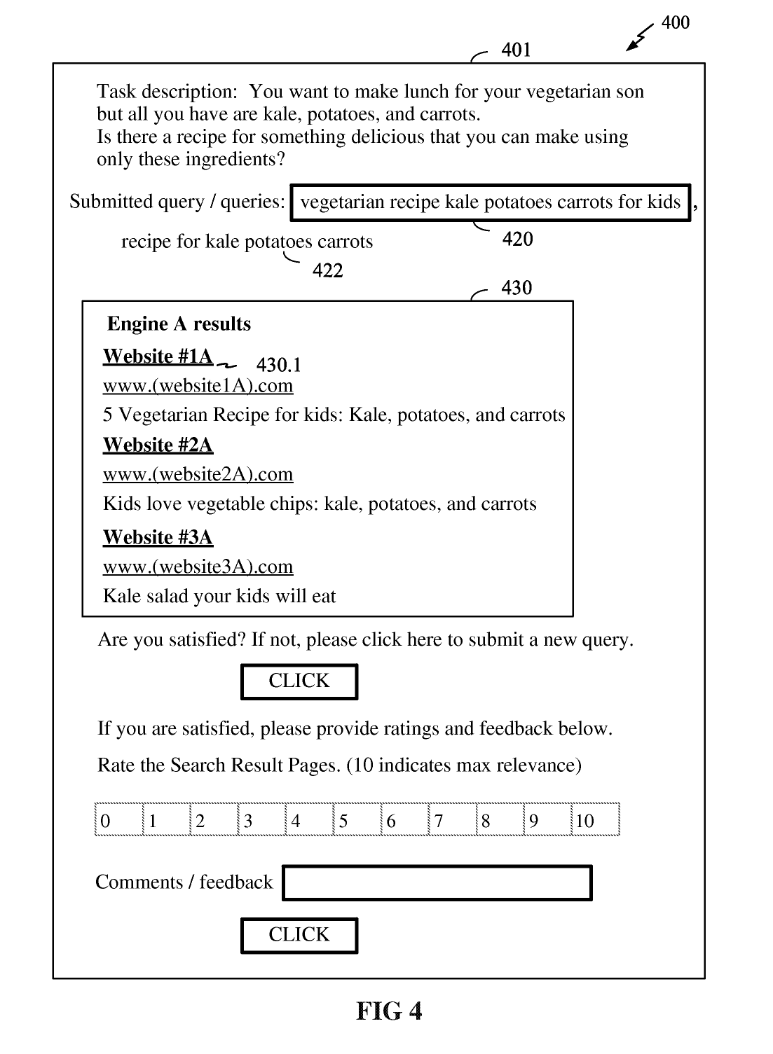

The results retrieved for Bob's query reformulation are illustratively shown in FIG. 4. The reformulated query string 420 has replaced the initial query string 422 (which may be displayed next to the current query string as shown), and corresponding results 430 retrieved and displayed. It will be appreciated that results 430 (including result 430.1) now specifically address the topic of recipes for children based on the reformulated query.

It will be appreciated that an advantage of the present disclosure is that an evaluator is provided with the option to reformulate the initial query, even if that initial query is pre-configured and not derived from the evaluator.

In an alternative exemplary embodiment, to improve rating sensitivity, task-level query reformulation techniques as described hereinabove may be combined with side-by-side display of results from different search engines. In particular, as noted hereinabove with reference to ratings 350, evaluators may be requested to assign a scaled rating of the effectiveness of search engine results. For example, the relevance score may be a value from 0-10, rather than a single binary metric indicating relevant or irrelevant. However, such a scaled rating may be difficult to assign in isolation, if the evaluator does not have a baseline for comparing a given set of results with some other reference, e.g., another set of more or less relevant results.

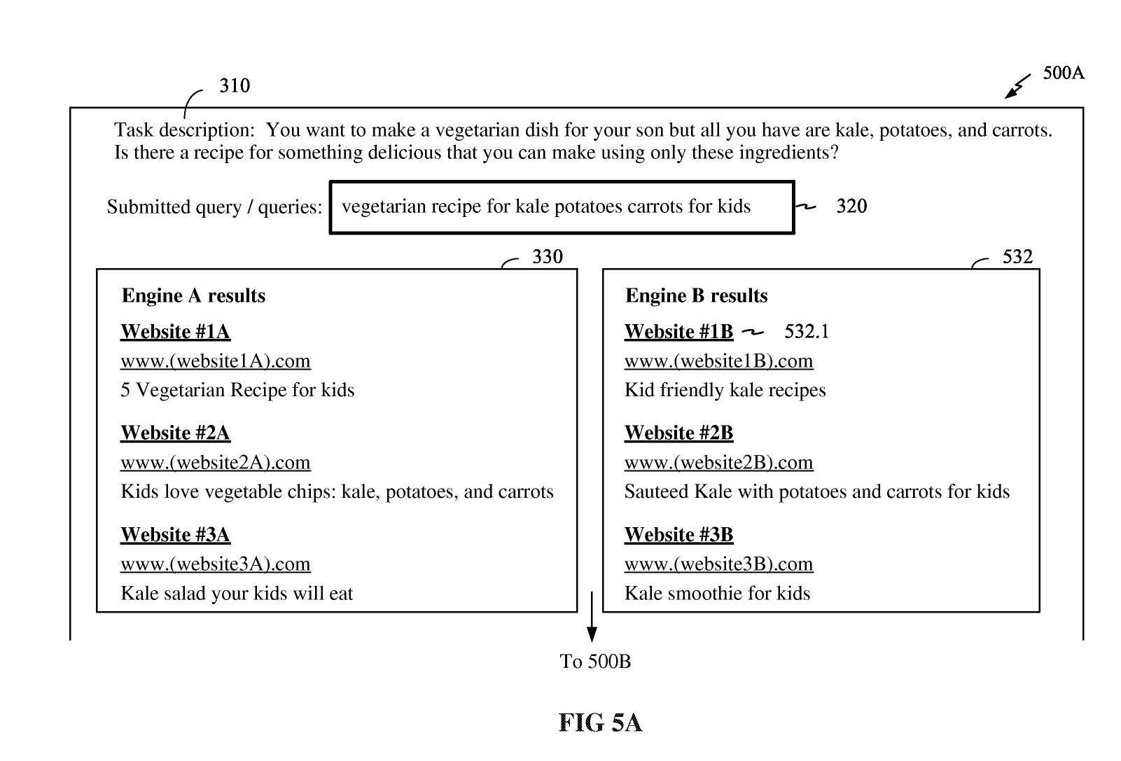

FIGS. 5A and 5B show an exemplary embodiment of a UI wherein a side-by-side (SBS) comparison of search results from different search engines is further displayed. Note similarly labeled elements in FIGS. 3 and 5A, 5B may correspond to elements performing similar functionality, unless otherwise noted.

In UI 500A of FIG. 5A, search results 330 returned by a first search engine labeled “Engine A” are shown on a side (e.g., left-hand side) of the screen. Note search results 330 may correspond to the same results 330 displayed in FIG. 3, wherein the same search engine as used in FIG. 3 was called on to execute the same query. On an alternate side (e.g., right-hand side) of the screen, search results 532 (including illustrative result 532.1) returned by a second search engine labeled “Engine B” are shown. In an exemplary embodiment, Engine A and Engine B may correspond to two different search engines, e.g., designed by different commercial entities. In an alternative exemplary embodiment, results from more than two search engines may also be displayed, as allowed by the size and resolution of the display.

As shown in UI 500B of FIG. 5B, which may be a continuation of the display shown in FIG. 5A, evaluator input may be received as a designation that the quality of Engine A's results is better or worse than the quality of Engine B's results. In an exemplary embodiment, the designation may be made using selection buttons 540 indicating relative preference for one engine's results over another. For example, clicking on button 542 may indicate that the evaluator considers Engine A to be much better than Engine B.

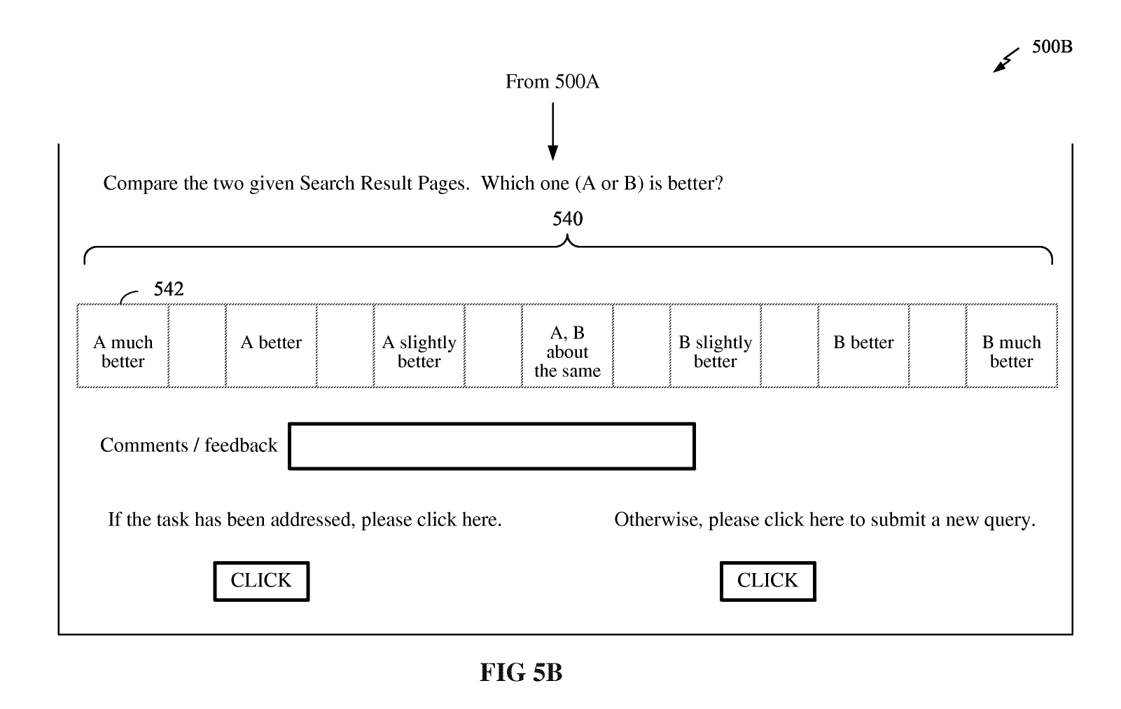

FIG. 6 illustrates an exemplary embodiment 600 of a search engine evaluation method utilizing side-by-side display according to the present disclosure.

In FIG. 6, at block 610, a task description is displayed through a user interface.

At block 620, an initial query string corresponding to the defined task description is received or generated.

At block 630, search results are retrieved from multiple search engines and displayed for evaluation. In particular, the initial query string from block 620 is submitted to each of the multiple search engines to be evaluated, and search results (e.g., the first page or first SERP) are retrieved from each of the search engines corresponding to the initial query. The results may then be displayed side-by-side through the user interface. For example, illustrative results 330 and 532 returned by a search engine A and B responsive to initial query 320 are shown in FIG. 5.

At block 640, behavioral signals may be collected from the evaluator.

At block 650, input is received regarding whether the evaluator believes the defined task has been satisfactorily addressed by the search results returned. If the evaluator indicates yes, e.g., method 600 continues to block 660. If the evaluator indicates no, method 600 continues to block 655.

At block 655, in response to the evaluator indicating unsatisfactory results, a new query string may be received from the evaluator, and logged.

Following block 655, method 600 returns to block 630, wherein the new query string is resubmitted to each of the multiple search engines, and search results (e.g., the first page or first SERP) from each engine are retrieved corresponding to the resubmitted query.

At block 660, upon receiving evaluator input that the defined task has been satisfactorily addressed (e.g., by any or all of the multiple search engines), the evaluator's feedback is collected. Such feedback may include, e.g., designation via selection buttons 540 indicating relative preference for one engine's results over another, as earlier described hereinabove. Further feedback received may include written answer to task 310, comments on why one search engine was deemed better than another, etc.

At block 670, all of the evaluator's feedback, signals, and activity logs are forwarded to an analysis module (not shown in FIG. 6) for further results processing.

Utilizing the techniques described hereinabove, accurate ratings regarding quality of search results may be obtained from evaluators. It will be appreciated that to further increase the accuracy and scope of search engine evaluation across a wide variety of subject areas and topics, it is desirable to collect feedback from a large number of human evaluators. Accordingly, techniques such as “crowd-sourcing” have been utilized, e.g., distributing the search engine evaluation task over large populations of potentially anonymous users, e.g., Internet users. While crowd-sourcing affords the advantage of a large population of evaluators, quality control becomes an issue, as crowd-sourcing participants may possess widely varying skills and incentives for performing the evaluations. In a further aspect of the present disclosure, techniques are provided for training and implementing a classifier for judging the quality of human evaluators, such as crowd-sourcing participants, using the evaluation platform and collected signals described hereinabove.

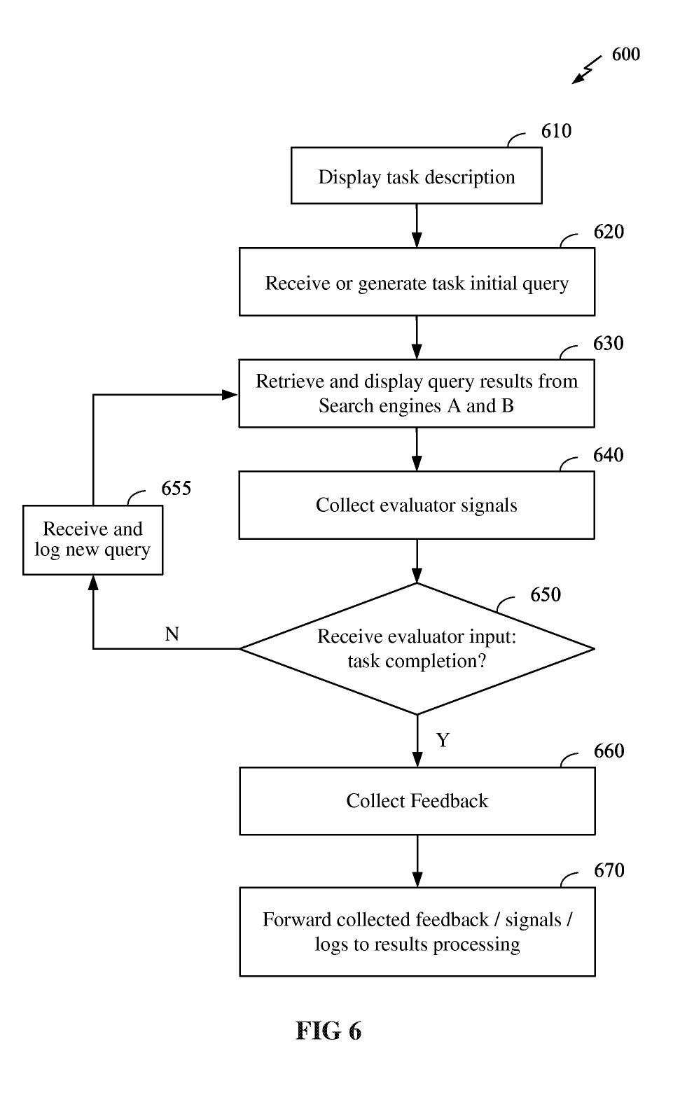

FIG. 7 illustrates an exemplary embodiment 700 of an evaluator quality classifier trainer using techniques of the present disclosure. Note FIG. 7 is shown for illustrative purposes only, and is not meant to limit the scope of the present disclosure.

In FIG. 7, signals 710 received from each of a plurality of reference evaluators are provided as input to classifier trainer 700. For example, signals 710.1 are collected from a first reference evaluator (Evaluator 1), signals 710.n are collected from an n-th reference evaluator (Evaluator n), and signals 710.N collected from an N-th reference evaluator (Evaluator N), etc. Signals 710 may correspond to, e.g., behavioral signals or other metrics, such as described hereinabove with reference to block 240 or 640. In certain exemplary embodiments, signals 710 may also include labels, e.g., indications supplied by an evaluator regarding how well a search engine performed for a given task as collected at block 260 or 660. Thus a single data point in signals 710.1 may include behavioral signals from an evaluator collected during execution of a task assignment, and/or a label (or rating) of search engine performance explicitly provided by the evaluator.

In an exemplary embodiment, each of Evaluator 1 through Evaluator N may specifically correspond to a “reference” evaluator, e.g., a human evaluator pre-screened to possess the desired accuracy and incentives with regards to search engine evaluation, and/or are known or trusted in advance to solve the evaluation tasks in a proper and correct manner. For example, each reference evaluator may be a trained judge paid by an evaluation entity for the specific purpose of evaluating search engine quality.

In an alternative exemplary embodiment, the identity of reference evaluators (e.g., “high-quality” evaluators) may be ascertained from amongst other evaluators based on their responses to certain “calibration” task descriptions. Such calibration tasks may be tasks having specific, precise answers, such as earlier described hereinabove with reference to Task Descriptions 4 and 5. For example, suppose each of 100 evaluators are assigned a list of 10 tasks for search engine evaluation, 2 tasks of which correspond to “calibration” tasks having known “correct” answers. Based on feedback collected from the 100 evaluators, e.g., at block 260 or 660, it may be determined which of the 100 evaluators provided correct answers to (either or both of the 2) calibration tasks. Those evaluators providing correct answers to the calibration tasks may then be pre-judged to be “high-quality” evaluators, and their feedback and/or ratings for the other (8 of 10) tasks may be weighted more heavily. Other techniques for assigning or determining the identity of reference evaluators are contemplated to be within the scope of the present disclosure.

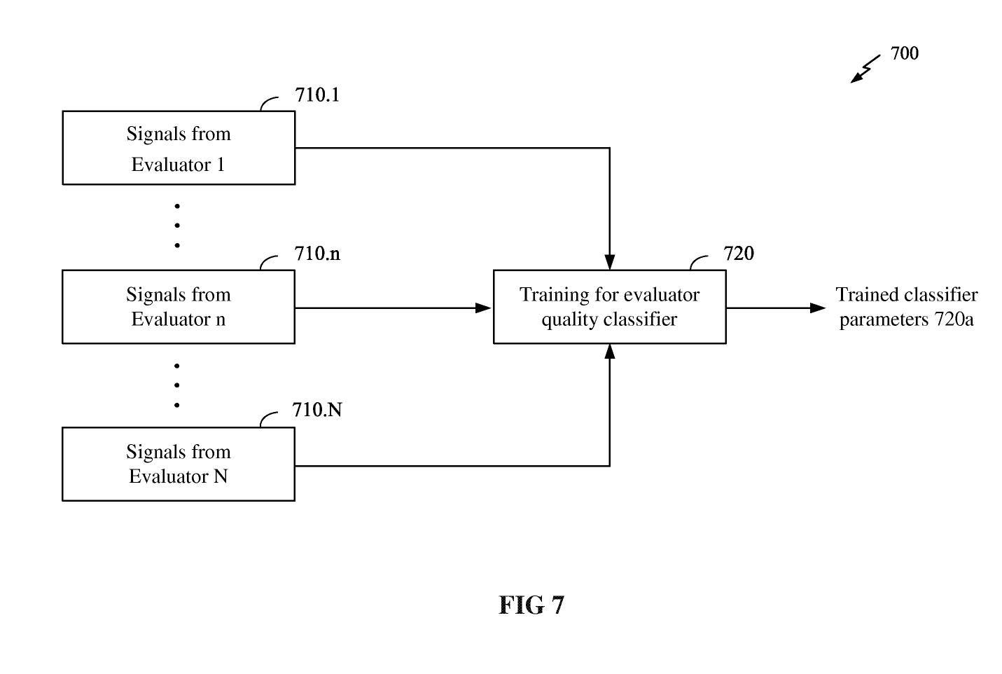

The signals from blocks 710.1 through 710.N are provided to training block 720 for an evaluator quality classifier. In an exemplary embodiment, training block 720 may derive a set of parameters 720a for optimally determining what types of behavioral signals would be associated with a “high-quality” evaluator. For example, an evaluator quality classifier (such as shown in FIG. 8 hereinbelow) could, based on trained classifier parameters 720a, classify the quality of an arbitrary evaluator (e.g., as “high-quality,” “low-quality,” or any other graded metric thereinbetween) based on behavioral signals collected from one or more iterations of methods 200 or 600 described hereinabove.

In an exemplary embodiment, techniques employed for such training may correspond to machine learning techniques, e.g., gradient boosted decision trees, Bayesian modeling, Logistic Regression, Support Vector Machine, Neural Networks etc. In particular, machine learning can be utilized to both identify behavioral factors upon which the evaluation can be based, e.g., by using feature engineering or Bayesian modeling of observable and latent behavior factors, etc., and to perform the classification of evaluator quality based on such factors, such as by using learning algorithms.

In an exemplary embodiment, Gradient Boosted Decision Trees (GBDT) may be used to generate a prediction model in the form of an ensemble of decision trees serving as weak prediction models. For example, the model may be built in a stage-wise fashion, and generalized by allowing optimization of an arbitrary differentiable loss function. At every training step, a single regression tree may be built to predict antigradient vector components. Step length may then be computed corresponding to the loss function and separately for every region determined by the tree leaf. It will be appreciated that advantages of GBDT include model interpretability (e.g., a ranked list of features is generated), facility for rapid training and testing, and robustness against noisy or missing data points.

FIG. 8 illustrates an exemplary embodiment 800 of an evaluator quality classifier according to techniques of the present disclosure. Note FIG. 8 is shown for illustrative purposes only, and is not meant to limit the scope of the present disclosure.

In FIG. 8, trained or pre-configured classifier parameters 720a are used to configure an evaluator quality classifier 810. In particular, classifier 810 receives as input evaluator signals 810a for a “candidate” evaluator, e.g., an evaluator whose quality is not known. Using parameters 720a and signals 810a, classifier 810 generates an output 810b indicative of the quality of the candidate evaluator.

In an exemplary embodiment, parameters 720a may correspond to, e.g., classifier weights or algorithms derived from training such as described with reference to FIG. 7. For example, such training may utilize machine learning techniques to both identify behavioral factors (or signals) upon which the evaluation can be based, and to perform the classification of evaluator quality based on such factors, as earlier described hereinabove. In an alternative exemplary embodiment, parameters 720a may correspond to pre-configured rules designed to perform classification of evaluator quality based on a pre-determined set of behavioral signals. In such cases, parameters 720a may correspond to “pre-configured” classifier parameters 720a that specify pre-configured rules for classifying evaluator quality.

For example, supposed it is observed for certain types of tasks that reference (e.g., reliable) evaluators are able to resolve those tasks without generating a single mouse click. In this instance, evaluator quality classifier 810 may be specifically configured via parameters 720a to discount or eliminate the weighted significance of quantity of mouse click events (e.g., which can be a behavioral signal collected at block 240 or block 640) in the determination of evaluator quality 810b. Conversely, if logged behavior of evaluators revealed that the average quantity of mouse click events generated by the reference evaluators corresponds to a certain number, e.g., six, with a standard deviation of one, then evaluator quality classifier 810 may be specifically configured via parameters 720a to adjust the estimated output 810b of evaluator quality by a suitable factor depending on the quantity of mouse clicks. For example, classifier 810 may multiply a quality indicator (e.g., a number from 0-100, with 100 indicating highest quality) by a multiplier factor related to a normal distribution of measured mouse click events in signals 810a, wherein the mean and standard deviation of the normal distribution may correspond to six and one, respectively. In an alternative exemplary embodiment, pre-configured classifier parameters 720a may specify that quantities of mouse click events less than a first threshold, e.g., five, or greater than a second threshold, e.g., ten, may indicate poor evaluator quality 810b.

Note the particular pre-configuration of classifier 810 based on mouse click events has been described as an illustrative exemplary embodiment of pre-configured classifier parameters 720a only, and is not meant to limit the scope of the present disclosure to the use of mouse click events as relevant behavioral signals, or to the use of any particular values for the mean or standard deviation illustratively described.

In an alternative exemplary embodiment, a “dwell time” for an evaluator may be measured as the time between when a search task is initially displayed to a reference evaluator and the first mouse click event. In this instance, pre-configured classifier parameters 720a may specify that dwell times of less than a first dwell time threshold, e.g., twenty seconds, and greater than a second dwell time threshold, e.g., two minutes, may indicate poor evaluator quality 810b.

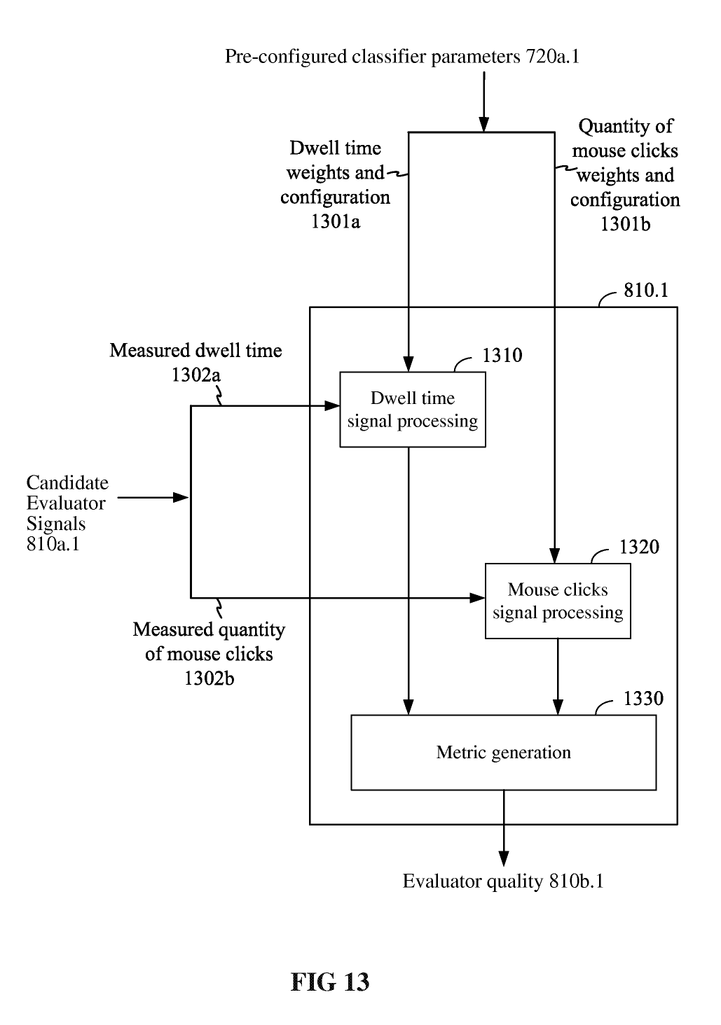

It will further be appreciated that a composite “behavioral metric” may readily be formed by aggregating two or more of the pre-configured “rules” described hereinabove. For example, any or all of signals 810a, including quantity of mouse clicks, dwell time, mouse hovering, mouse swipe information, etc., may be separately weighted and combined to derive a single composite behavioral metric that can be used as an indicator of evaluator quality. In an exemplary embodiment, classifier 810 can be pre-configured via parameters 720a to determine a difference between the value of such composite behavioral metric and a reference value for such composite behavioral metric (e.g., corresponding to signals as would be expected from a reference evaluator), and to generate the evaluation 810b of evaluator quality based on the magnitude of such difference. In an exemplary embodiment, if the quality 810b of a candidate evaluator is determined to be poor, then evaluations from such candidate evaluator may be removed, and/or the candidate evaluator may be re-trained. For illustrative purposes, an exemplary embodiment 810.1 of classifier 810 is further described hereinbelow with reference to FIG. 13.

In an exemplary embodiment, it will be appreciated that the techniques for collecting behavioral signals and feedback from evaluators, e.g., as described with reference to FIGS. 2 and 6, may be implemented using separate hardware from the techniques for training an evaluator quality classifier and/or classifying evaluator quality, e.g., as described with reference to FIGS. 7 and 8. For example, search engine evaluation methods 200 and 600 may be executed using software stored in memory coupled to a processor residing on a “client” or “front-end” machine, e.g., a personal or laptop computer, smartphone, tablet, etc., used by an evaluator. Feedback and behavioral signals from evaluators may be collected by the client and transmitted to a “server” or “back-end” machine, e.g., a computer server with extensive processing capabilities communicating with a plurality of clients over a network, e.g., Internet connection. In an exemplary embodiment, evaluator quality classification 800 and training 700 may be executed using software stored in memory coupled to a processor residing on a server machine.

In an alternative exemplary embodiment, evaluation 200 or 600 may be executed by a client machine, and training 700 may be executed by a server machine, while classification 800 may be executed by the same client machine used to execute evaluation 200 or 600, e.g., weights and algorithms derived from training 700 may be transmitted to the client machine over a network connection. In a further alternative exemplary embodiment, techniques for collecting behavioral signals and feedback may be implemented using the same hardware as the techniques for training an evaluator quality classifier and/or classifying evaluator quality, e.g., a single terminal may be provided for the functions of generating and displaying the UI, collecting the feedback and behavioral signals, training the evaluator quality classifier, and classifying candidate evaluators. Such alternative exemplary embodiments are contemplated to be within the scope of the present disclosure.

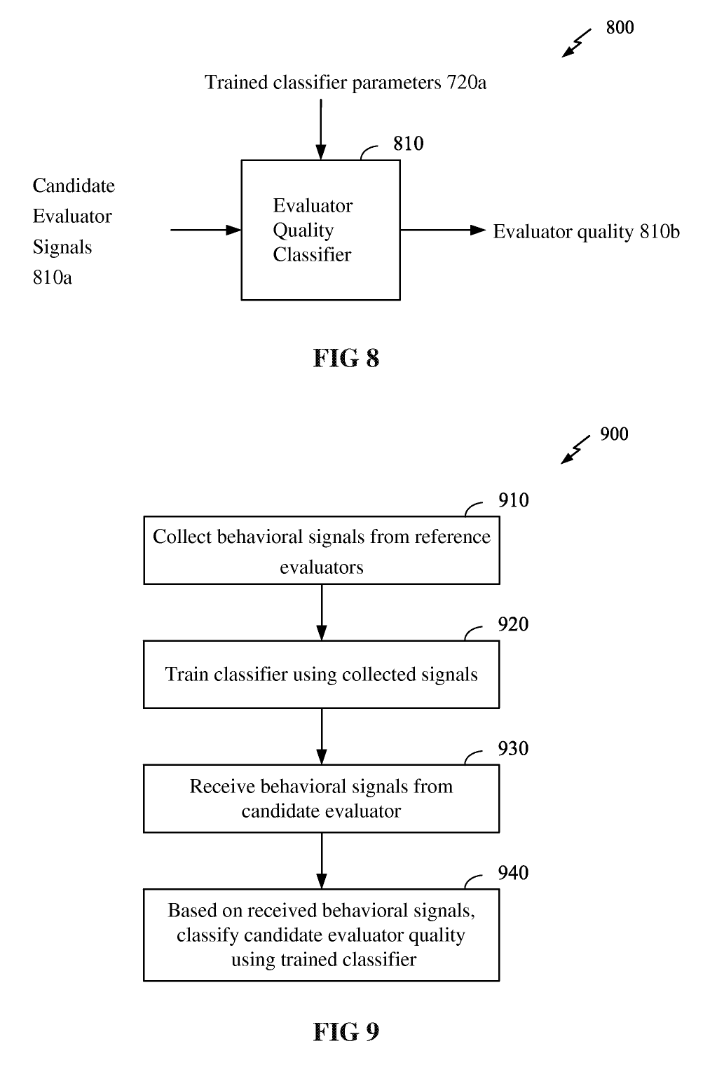

FIG. 9 illustrates an exemplary embodiment 900 of a method for training and classifying evaluators according to the present disclosure. In FIG. 9, at block 910 behavioral and label data is collected from reference evaluators. In an exemplary embodiment, such data may correspond to, e.g., data as described with reference to blocks 710.1 through 710.N in FIG. 7.

At block 920, an evaluator quality classifier is trained using the collected data, e.g., as described hereinabove with reference to training 700 in FIG. 7.

At block 930, behavioral signals are received from a candidate evaluator. Such behavioral signals may correspond to, e.g., signals as collected at block 240 or 640.

At block 940, based on the received behavioral signals, candidate evaluator quality is classified using a classifier. In an exemplary embodiment, the classifier may correspond to classifier 810 as described hereinabove with reference to FIG. 8.

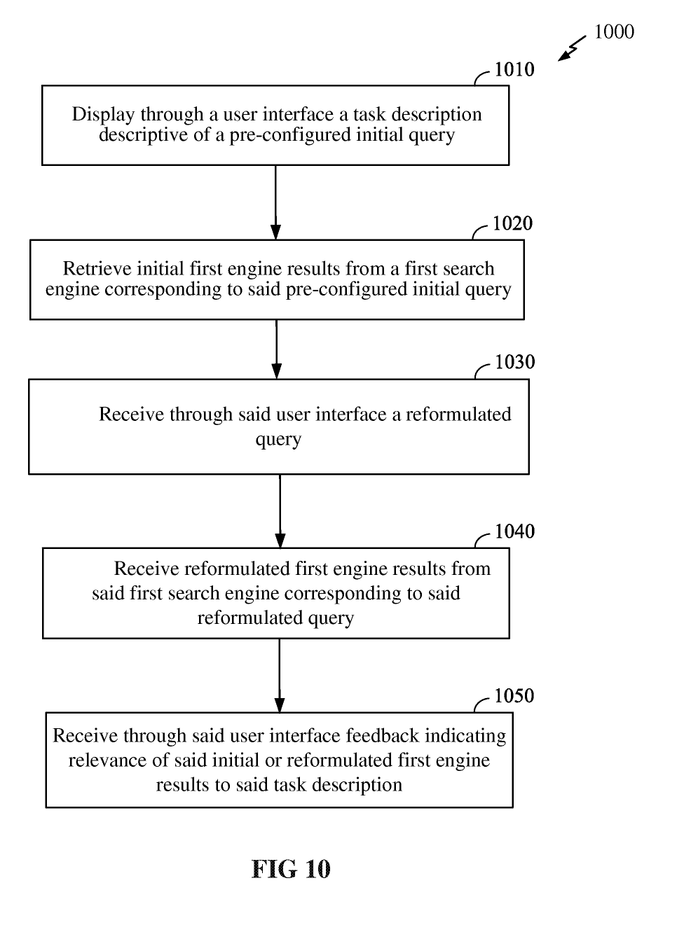

FIG. 10 illustrates an exemplary embodiment 1000 of a method according to the present disclosure. Note FIG. 10 is shown for illustrative purposes only, and is not meant to limit the scope of the present disclosure to any particular exemplary embodiment of a method shown.

In FIG. 10, at block 1010, a task description descriptive of a pre-configured initial query is displayed through a user interface. At block 1020, initial first engine results are retrieved from a first search engine corresponding to said pre-configured initial query. At block 1030, a reformulated query is received through said user interface. At block 1040, reformulated first engine results are received from said first search engine corresponding to said reformulated query. At block 1050, feedback is received through said user interface indicating relevance of said initial or reformulated first engine results to said task description.

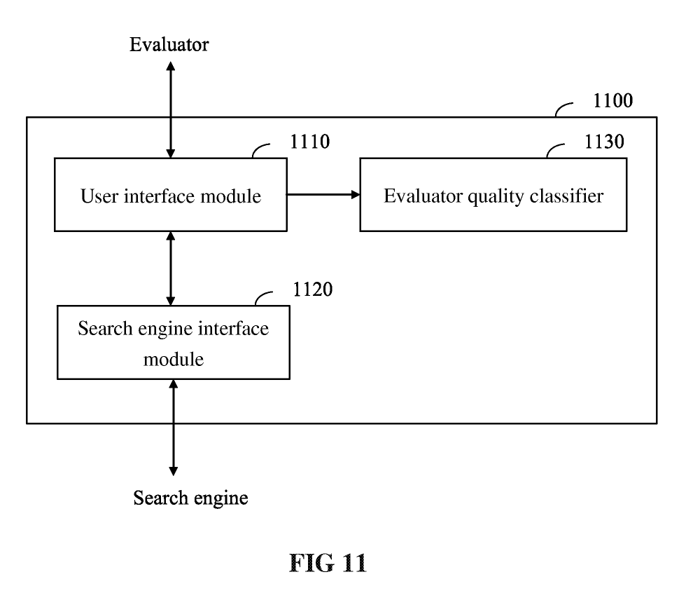

FIG. 11 illustrates an exemplary embodiment 1100 of an apparatus according to the present disclosure. Note FIG. 11 is shown for illustrative purposes only, and is not meant to limit the scope of the present disclosure to any particular exemplary embodiment of an apparatus shown.

In FIG. 11, apparatus 1100 comprises a search engine interface module 1110 configured to retrieve initial first engine results from a first search engine corresponding to a pre-configured initial query; and a user interface module 1120 configured to display a task description descriptive of said pre-configured initial query, and to receive a reformulated query. The search engine interface module 1110 is further configured to receive reformulated first engine results from said first search engine corresponding to said reformulated query. The user interface module 1120 is further configured to display said initial and reformulated first engine results, and to receive feedback indicating relevance of said initial or reformulated first engine results.

In an exemplary embodiment, apparatus 1100 may further comprise an evaluator quality classifier 1130 configured to receive said at least one behavioral signal from a candidate evaluator; and based on said received behavioral signals, generate a quality classification of said candidate evaluator.

In an alternative exemplary embodiment, apparatus 1100 may include more than one physically separate machine, e.g., modules 1110 and 1120 may be implemented on a first machine, while classifier 1130 is implemented on a second machine, and the two machines may communicate using a communications channel, e.g., an Internet connection.

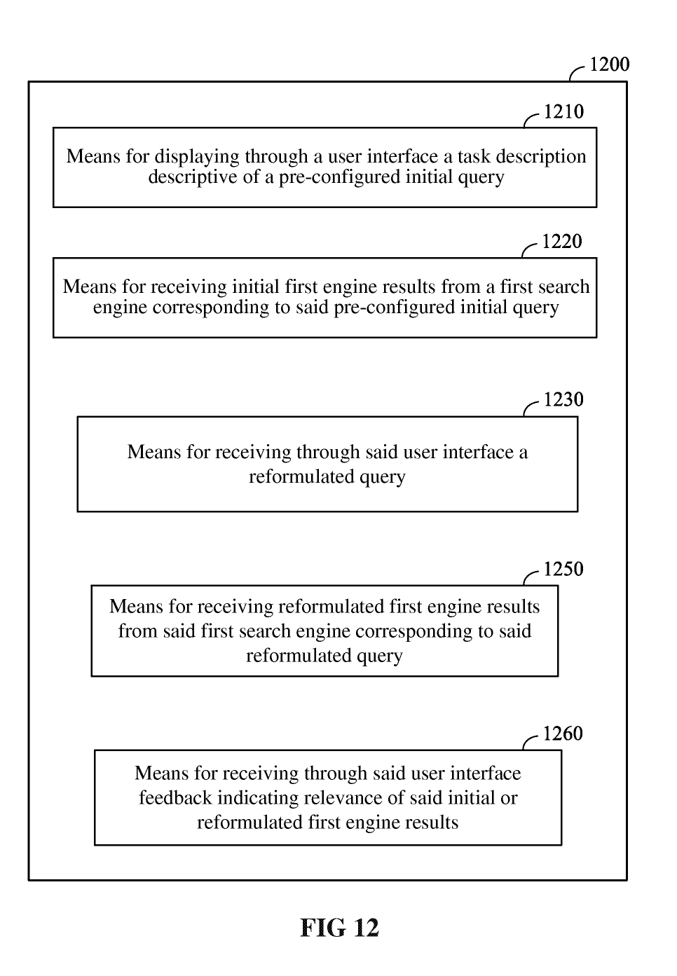

FIG. 12 illustrates an alternative exemplary embodiment 1200 of an apparatus according to the present disclosure. Note FIG. 12 is shown for illustrative purposes only, and is not meant to limit the scope of the present disclosure to any particular exemplary embodiment of an apparatus shown.

In FIG. 12, apparatus 1200 comprises means 1210 for displaying a task description descriptive of a pre-configured initial query through a user interface; means 1220 for retrieving initial first engine results from a first search engine corresponding to said pre-configured initial query; means 1230 for receiving through said user interface a reformulated query; means 1240 for receiving reformulated first engine results from said first search engine corresponding to said reformulated query; and means 1250 for receiving through said user interface feedback indicating relevance of said initial or reformulated first engine results.

FIG. 13 illustrates an exemplary embodiment 810.1 of evaluator quality classifier 810 according to the present disclosure. Note classifier 810.1 is shown for illustrative purposes only, and is not meant to limit the scope of the present disclosure to any particular types of signals, metrics, or classifiers.

In FIG. 13, an exemplary embodiment 720a.1 of classifier parameters 720a includes configuration parameters 1301a for a “dwell time” signal, and configuration parameters 1301b for a “quantity of mouse clicks” signal. In an exemplary embodiment, parameters 1301a, 1301b may each include, e.g., means and standard deviations of reference values for the corresponding quantities, multiplier weights (e.g., weights that may be used to adjust the relative importance of dwell time versus quantity of mouse click signals in deriving an optimum behavioral metric), etc. Exemplary embodiment 810a.1 of candidate evaluator signals 810a includes measured dwell time 1302a and measured quantity of mouse clicks 1302b as component signals.

Measured dwell time 1302a and dwell time weights and configuration parameters 1301a are provided to a dwell time signal processing block 1310 of classifier 810.1. In an exemplary embodiment, block 1310 may, e.g., derive a factor (e.g., a “processed dwell time signal”) quantifying a comparison of measured dwell time 1302a versus reference values for the dwell time, e.g., as specified by means and standard deviations in parameters 1301a. Block 1310 may further normalize the derived factor so that it may be commensurately combined with other signal factors (e.g., as calculated by block 1320) to generate a composite behavioral metric.

Similarly, quantity of mouse clicks 1302b and quantity of mouse clicks weights and configuration parameters 1301b are provided to a mouse click signal processing block 1320 of classifier 810.1. In an exemplary embodiment, block 1320 may, e.g., derive a factor (e.g., a “processed number of mouse click events signal”) quantifying a comparison of measured quantity of mouse clicks 1302b versus reference values for the quantity of mouse clicks, e.g., as specified by means and standard deviations in parameters 1301b. Block 1320 may further normalize the derived factor so that it may be commensurately combined with other signal factors (e.g., as calculated by block 1310) to generate the composite behavioral metric.

The outputs of blocks 1310 and 1320 are provided to a metric generation block 1330, which may generate a composite metric 810b.1 indicative of evaluator quality. In an exemplary embodiment, block 1330 may perform addition of the signals provided to it, or block 1330 may perform any other operations needed to process the separate signals to generate a single composite metric.

Note while classifier 810.1 has been described for illustrative purposes, it is not meant to limit the scope of the present disclosure to classifiers utilizing only the signals shown, or to those classifiers that can be formulated in the manner shown in FIG. 13. It will be appreciated that classifiers such as derived from, e.g., machine learning techniques, may generally adopt architectures wherein relationships between classifier output 810b and individual signals in 810a are not as readily apparent as shown in FIG. 13. In particular, machine learning techniques may generally derive highly complex and/or non-linear relationships between signals 810a and a evaluator quality metric 810b, and it will be appreciated that the capacity to accommodate such complex relationships between input and output is an advantage of machine learning implementations of classifier 810, versus, e.g., pre-configured classifiers such as shown in FIG. 13. In an alternative exemplary embodiment, machine learning techniques may be further combined with the pre-configured rules to derive optimum behavioral metrics. All such alternative exemplary embodiments are contemplated to be within the scope of the present disclosure.

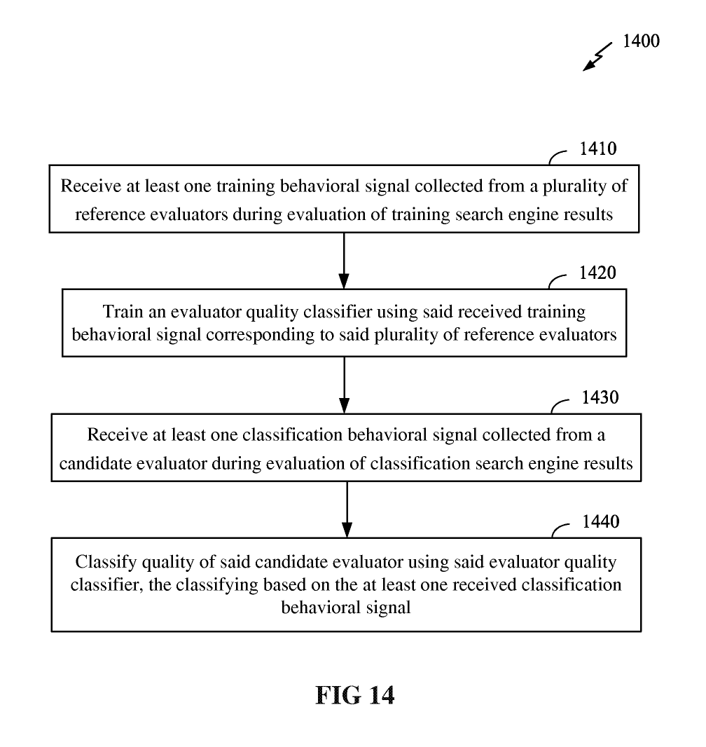

FIG. 14 illustrates an alternative exemplary embodiment 1400 of a method according to the present disclosure. In FIG. 14, at block 1410, at least one training behavioral signal collected from a plurality of reference evaluators during evaluation of training search engine results is received. At block 1420, an evaluator quality classifier is trained using said received training behavioral signals corresponding to said plurality of reference evaluators. At block 1430, at least one classification behavioral signal collected from a candidate evaluator during evaluation of classification search engine results is received. At block 1440, quality of said candidate evaluator is classified using said evaluator quality classifier. The classifying may be based on collected behavioral signals corresponding to said candidate evaluator.

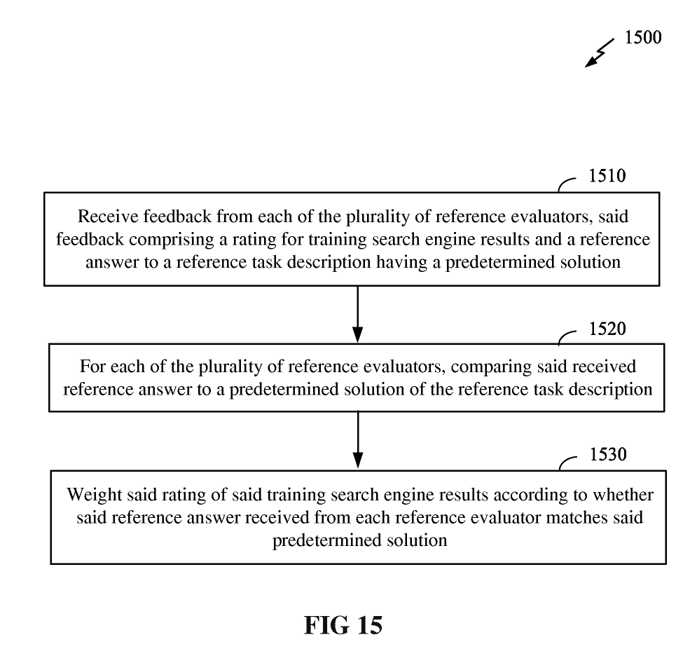

FIG. 15 illustrates a further alternative exemplary embodiment 1500 of a method according to the present disclosure. In FIG. 15, further to method 1400 of FIG. 14, at block 1510, feedback is received from each of the plurality of reference evaluators, said feedback comprising a rating for said training search engine results and a reference answer to a reference task description having a predetermined solution. At block 1520, further to block 1420 of FIG. 14, the training further comprises: for each of the plurality of reference evaluators, comparing said received reference answer to a predetermined solution of the reference task description at block 1520, and weighting said rating of said training search engine results according to whether said reference answer received from each reference evaluator matches said predetermined solution at block 1530.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present. Furthermore, when an element is referred to as being “electrically coupled” to another element, it denotes that a path of low resistance is present between such elements, while when an element is referred to as being simply “coupled” to another element, there may or may not be a path of low resistance between such elements.

The functionality described herein can be performed, at least in part, by one or more hardware and/or software logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

1. A method comprising:
displaying through a user interface a task description descriptive of a pre-configured initial query;
receiving initial first engine results from a first search engine corresponding to said pre-configured initial query;
receiving through said user interface a reformulated query;
receiving reformulated first engine results from said first search engine corresponding to said reformulated query; and
receiving through said user interface feedback indicating relevance of said initial or reformulated first engine results to said task description.

2. The method of claim 1, further comprising extracting keywords from said task description to generate said pre-configured initial query.

3. The method of claim 1, further comprising:
receiving initial second engine results from a second search engine corresponding to said pre-configured initial query;
displaying side-by-side said initial first engine results and initial second engine results through said user interface.

4. The method of claim 3, further comprising:
receiving reformulated second engine results from said second search engine corresponding to said reformulated query;
displaying side-by-side said reformulated first engine and second engine results through said user interface; said receiving feedback further comprising receiving feedback indicating preference for initial or reformulated first engine results over initial or reformulated second engine results.

5. The method of claim 1, further comprising:
collecting behavioral signals through said user interface corresponding to said displaying, said receiving the initial first engine results, said receiving the input, said receiving the reformulated query, said receiving the reformulated first results, or said receiving the feedback.

6. The method of claim 1, said behavioral signals comprising at least one of time spent on evaluating a task description, time spent outside evaluating said task description, number of logged mouse move events during evaluation of a task description, number of logged mouse move events per second during evaluation of a task description.

7. The method of claim 1, further comprising:
repeating over a plurality of task descriptions said displaying, said receiving the initial first engine results, said receiving the input, said receiving the reformulated query; said receiving the reformulated first engine results, and said receiving the feedback; and
collecting said behavioral signals corresponding to a plurality of evaluators over said plurality of task descriptions.

8. An apparatus comprising:
a search engine interface module configured to receive initial first engine results from a first search engine corresponding to a pre-configured initial query; and
a user interface module configured to display a task description descriptive of said pre-configured initial query, and to receive a reformulated query;
the search engine interface module further configured to receive reformulated first engine results from said first search engine corresponding to said reformulated query; and
the user interface module further configured to display said initial and reformulated first engine results, and to receive feedback indicating relevance of said initial or reformulated first engine results to said task description.

9. The apparatus of claim 8, the search engine interface module further configured to receive initial second engine results from a second search engine corresponding to said initial query, the user interface module further configured to display side-by-side said initial first engine results and initial second engine results.

10. The apparatus of claim 8, the user interface module further configured to collect at least one behavioral signal from an evaluator performing a search task corresponding to said task description.

11. The apparatus of claim 10, the at least one behavioral signal comprising at least one of time spent on evaluating a task description, time spent outside evaluating said task description, number of logged mouse move events during evaluation of a task description, number of logged mouse move events per second during evaluation of a task description.

12. The apparatus of claim 10, further comprising an evaluator quality classifier configured to:
receive said at least one behavioral signal from a candidate evaluator; and
based on said received behavioral signals, generate a quality classification of said candidate evaluator.

13. A method comprising:
receiving at least one training behavioral signal collected from a plurality of reference evaluators during evaluation of training search engine results;
training an evaluator quality classifier using said received training behavioral signal corresponding to said plurality of reference evaluators;
receiving at least one classification behavioral signal collected from a candidate evaluator during evaluation of classification search engine results; and
classifying quality of said candidate evaluator using said evaluator quality classifier, the classifying based on the at least one received classification behavioral signal.

14. The method of claim 13, said training corresponding to minimizing the expected value of a loss function using gradient boosted decision trees.

15. The method of claim 13, the at least one training behavioral signal and the at least one classification behavior signal being collected from each of said plurality of reference evaluators and said candidate evaluator in response to a task description being displayed through a user interface, the at least one training behavioral signal further being collected in response to at least one of said plurality of reference evaluators reformulating an initial query to retrieve reformulated search engine results during evaluation of said training search engine results.

16. The method of claim 13, said at least one training behavioral signal comprising at least one of time spent on a task by a reference evaluator, frequency of mouse clicks performed by said reference evaluator, location of mouse clicks performed by said evaluator, time spent outside a task by said reference evaluator, and number of mouse movements per task spent by the evaluator.

17. The method of claim 13, said at least one training behavioral signal comprising at least one of a dwell time between when a search task is initially displayed to a reference evaluator and a first mouse click event by said reference evaluator.

18. The method of claim 13, said classifying quality further comprising:
comparing a numerical value of a first one of said at least one classification behavioral signal to a first threshold; and
adjusting a numerical quality metric assigned to said candidate evaluator based on the result of said comparing.

19. The method of claim 18, said classifying quality further comprising:
comparing a numerical value of a second one of said at least one classification behavioral signal to a second threshold; and
further adjusting said numerical quality metric assigned to said candidate evaluator based on the result of said comparing said numerical value of said second one of said at least one classification behavioral signal to the second threshold.

20. The method of claim 13, further comprising:
receiving feedback from each of the plurality of reference evaluators, said feedback comprising a rating for said training search engine results and a reference answer to a reference task description having a predetermined solution; the training further comprising:
for each of the plurality of reference evaluators, comparing said received reference answer to a predetermined solution of the reference task description; and
weighting said rating of said training search engine results according to whether said reference answer received from each reference evaluator matches said predetermined solution.
